(19) United States
(12) Patent Application Publication
(10) Pub. No.: US 2006/0055884 A1
(43) Pub. Date: Mar. 16, 2006

(54) Soft contact lenses with stiffening rib features therein

(76) Inventors: Jason Emanuele Molinari, Atlanta, GA (US); Courtney Flem Morgan, Alpharetta, GA (US); Joseph Michael Lindacher, Suwanee, GA (US); Rafael Victor Andino, Lawrenceville, GA (US); S. Kay Fisher, Suwanee, GA (US); Tracy J. Snowden, Smyrna, GA (US); Jian Zhou, Duluth, GA (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/196,908

(22) Filed: Aug. 4, 2005

Related U.S. Application Data
(60) Provisional application No. 60/598,869, filed on Aug. 4, 2004.

(51) Int. Cl. G02C 7/02

(52) U.S. Cl. 351/177

(57) ABSTRACT

The present invention is related to a method for designing and making a contact lens which comprises stiffening rib features that provide even distribution of pressure from the lens over the cornea of an eye and/or allows the lens structure to maintain balance of forces for consistent and correct lens orientation on an eye during lens translation or eye lid movement. The invention also provides a soft contact lens comprising stiffening rib features that provides localized directional reinforcements to the lens structure to evenly distribute pressure from the lens over the cornea of an eye and/or to maintain balance of forces for consistent and correct lens orientation on an eye during lens translation or eye lid movement.

This application claims the benefit under 35 USC § 119(e) of U.S. provisional application No. 60/598,869 filed Aug. 4, 2004, incorporated by reference in its entirety.

This invention is related to contact lenses. In particular, the present invention is related to a method for providing localized stiffness to a soft contact lens at a desired location while having minimal impact on overall softness of a soft contact lens, a method for reducing excessive and localized pressure on the cornea by incorporating a stiffening rib feature to spread a dynamic load causing the excessive and localized pressure over an enlarged lens portion, thereby providing substantially even distribution of pressure from the lens over the cornea of an eye, and a method for maintaining balance of forces for consistent and correct on-eye orientation of a soft contact lens during lens translation or eye lid movement. The invention further provides a contact lens comprising stiffening rib features that provides localized directional reinforcements to the lens structure to maintain balance of forces for consistent and correct lens orientation on an eye during lens translation or eye lid movement.

### BACKGROUND

Soft contact lenses have alleviated some of the problems that patients have experienced in not being able to wear hard contact lenses (e.g., RGP lenses) or in not being able to wear them for sufficiently long periods of time, because of initial discomfort (i.e., immediately after lens insertion), relatively long period of adapting time (a week or two) required for a patient to become accustomed to them, and/or improper fit (lenses become dislodged and/or are very uncomfortable). This is due, not only, to their relatively soft surfaces, but also to their pliability, which permits them to modify their shape somewhat with different eyes. However, be cause of this pliability which permits the lenses to flex to conform more closely to the underlying corneal shape, a soft lens can have undesirable lens flexures under the influence of the eyelids and/or lens movement. Such lens flexures may have adverse effects on the lens orientation stability (consistent and correct lens orientation) on eye and/or vertical translation of the optical zones of a translating bifocal soft contact lens across the pupil when the eye changes from primary (horizontal) gaze to a downward gaze.

In addition, some orientation stabilizing and/or translating features incorporated in a soft toric or translating bifocal contact lens may inadvertently change local mechanical properties of the lens structure so that pressure from the lens could not be evenly distributed over the cornea of an eye. Examples of such orientation stabilizing and/or translating features include a prism ballast which is generally a base-down prism to increases the mass of the lower portion of the lens and to create a weighting effect to orient the lens), a ridge which engages with lower eyelids to provide vertical translation support (see commonly assigned U.S. patent application publication Nos. 2002/0021410 and 2004/0017542), a facet in which parts of the lens geometry is removed to control the lens orientation, and double slab-off features which have a top slab-off zone and a bottom slab-off zone zones to maintain the lens orientation on the eye. These features may impart unevenly localized dynamic loads onto certain areas of the lens and may generate excessive or localized pressure on the cornea. Excessive or localized pressure on the cornea can have effects on epithelial cell function and staining can occur. It is desirable to evenly distribute the pressure from the lens over the cornea.

Therefore, there is a need for a method of designing and making a contact lens which is characterized by having an even distribution of pressure from the lens over the cornea of an eye and/or by being able to maintain balance of forces for consistent and correct lens orientation on an eye during lens translation or eye lid movement. There is also a need for a contact lens comprising features that provides localized and directional reinforcements to the lens structure to evenly distribute pressure from the lens over the cornea of an eye and/or to maintain balance of forces for consistent and correct lens orientation on an eye during lens translation or eye lid movement.

### SUMMARY OF THE INVENTION

There is provided, in accordance with one aspect of the invention, a method for making a soft contact lens which is characterized by having an even distribution of pressure from the lens over the cornea of an eye. The method of the invention comprises a step of incorporating at least one stiffening rib feature in or near an area having localized and excessive pressure in a non-optical zone of a contact lens to provide localized stiffening effects on lens structure and to have a dynamic load causing the localized and excessive pressure to be spread over an enlarged area, thereby providing an even distribution of pressure from the lens over the cornea of an eye.

The invention, in another aspect, provides a method for a soft contact lens which is characterized by being able to maintain balance of forces for consistent and correct on eye lens orientation. The method of the invention comprises a step of incorporating at least one pair of stiffening rib features in a non-optical zone of a contact lens having a vertical meridian and a mirror symmetry relative to the vertical meridian plan, wherein each of the pair of stiffening rib features is arranged on either side of the vertical meridian plane to provide localized and directional stiffening effects on lens structure, wherein combination of the directions of the pair of stiffening rib features is parallel to the vertical meridian.

The invention, in a further aspect, provides a soft contact lens which is characterized by being able to maintain balance of forces for consistent and correct lens orientation on an eye during lens translation or eye lid movement. The contact lens of the invention comprises an anterior surface, an opposite posterior surface, a vertical meridian plane and at least one pair of stiffening rib features. The anterior surface has a mirror symmetry with respect to the vertical meridian plane, is continuous at least in first derivative, and includes a vertical meridian, a horizontal meridian, a central optical zone and a peripheral zone extending outwardly from the central optical zone to lens edge. The pair of stiffening rib features are located in the peripheral zone and on either side of the vertical meridian plane to provide localized and directional stiffening effects on lens structure, wherein combination of the directions of the pair of stiffening rib features is parallel to the vertical meridian.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE DRAWINGS

FIG. 1 illustrates a plan view of the anterior surface of a contact lens according to a preferred embodiment of the invention.

### DETAILED DESCRIPTION OF THE PREFERRED EMBODIMENTS

Reference now will be made in detail to the embodiments of the invention. It will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well known and commonly employed in the art.

A “contact Lens” refers to a structure that can be placed on or within a wearer's eye. A contact lens can correct, improve, or alter a user's eyesight, but that need not be the case. A soft contact lens is prepared from a hydrogel material. Typically, a contact lens has an anterior surface and an opposite posterior surface and a circumferential edge where the anterior and posterior surfaces are tapered off.

As used herein, a “multifocal” contact lens can be a bifocal lens, a trifocal lens, a multifocal lens, or a progressive multifocal lens.

A “hydrogel” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers.

A “silicone hydrogel” refers to a hydrogel obtained by copolymerization of a polymerizable composition comprising at least one silicone-containing vinylic monomer or at least one silicone-containing macromer.

The “front surface” or “anterior surface” of a contact lens, as used herein, refers to the surface of the lens that faces away from the eye during wear. The anterior surface, which is typically substantially convex, may also be referred to as the front curve of the lens.

The “back surface” or “posterior surface” of a contact lens, as used herein, refers to the surface of the lens that faces towards the eye during wear. The posterior surface, which is typically substantially concave, may also be referred to as the base curve of the lens.

Each of the anterior and posterior surfaces of a contact lens can comprises a central optical zone and one or more non-optical zones (or peripheral zones) surrounding the central

A “height” of a stiffening rib feature is defined as a point, along the intersection curve of a semi-meridian plane with the anterior surface and the stiffening rib feature, which has a maximum departure from the anterior surface. A person skilled in the art will know how to extrapolate the anterior surface below a stiffening rib feature and how to determine departure profile of the stiffening rib feature based on the extrapolation of the anterior surface below the stiffening rib feature. A line connecting all points each representing a height of a stiffening rib feature is defined as a “height line” of a stiffening rib feature. The maximum height of a stiffening rib feature of the invention can be up to about 150 microns above the anterior surface of a lens, preferably up to about 100 microns above the anterior surface of a lens, more preferably up to about 75 microns above the anterior surface of a lens.

In accordance with the invention, the shape of a stiffening rib feature is defined by projecting a 20%-maximum height isoline, which is a line on the surface of a stiffening rib feature that represents a constant departure of 20% of the maximum height of the stiffening rib feature from the anterior surface, onto a plane perpendicular to the vertical meridian plane of the lens. A stiffening rib feature of the invention can have any shape including, without limitation, rectangular, triangular, oval, polygonal, sticklike, arc-like, curvilinear, or the like. Preferably, a stiffening rib feature assume a rectangular, sticklike or arc-like shape. More preferably, a stiffening rib feature of the invention has a shape of an arc which is substantially concentric with the geometrical center of the lens.

In accordance with the invention, both the maximum width and the maximum length of a stiffening rib feature are defined as a distance between a pair of points on the 20%-maximum height isoline, as known to a person skilled in the art. The maximum width of a stiffening rib feature of the invention is preferably about 2.0 mm or less, more preferably about 1.5 mm or less, even more preferably about 1.0 mm or less. The maximum length of a stiffening rib feature of the invention is preferably from about 2.0 mm to about 10.0 mm.

In accordance with the invention, an “even distribution of pressure from the lens over the cornea of an eye” is characterized by having a lens fluorescein pattern without “bearing” area. More preferably a lens fluorescein pattern showing substantially uniform fluorescence intensity.

A “continuous transition”, in reference to two or more zones, means that these zones are continuous at least in first derivative, preferably in second derivative.

“Lens thickness” refers to a shortest distance from a point on the anterior surface to the posterior surface of a contact lens.

“Tangent surface patches” refer to combinations of surfaces with curvatures that are continuous in first derivative, preferably in second derivative, from each other.

A “customized contact lens”, as used herein, means: (1) a contact lens that is designed using input of wavefront aberration measurements of an eye of an individual and be able to correct higher-order wavefront aberrations; and/or (2) a contact lens that has a posterior surface accommodating the corneal topography of an eye of an individual or a corneal topography statistically represent a segment of population.

The wavefront aberrations of an eye of an individual can be determined by any suitable methods known to one skilled in the art, including without limitation, Shack-Hartmann techniques, Tscherning techniques, retinal raytracing techniques, and spatially-resolved refractometer techniques. For example, Liang et al. in J. Optical Soc. Am. 11:1-9, the entirety of which are herein incorporated by reference, teach how to determine wavefront aberrations of an eye at various pupil diameters using a Hartmann-Shack system. The wavefront aberrations generally are quantified in Zernike polynomials which are a set of functions that are orthogonal over the unit circle. Since Zernike polynomials are orthogonal, the aberrations are separable and can be treated as such. The first order Zernike modes are the linear terms. The second order Zernike modes are the quadratic terms, which correspond to the aberrations such as defocus and astigmatism. The third order Zernike modes are the cubic terms, which correspond to the coma and coma-like aberrations. The fourth order Zernike modes contain spherical aberrations as well as other modes. The fifth Zernike modes are the higher-order, irregular aberrations. Local irregularities in the wavefront within the pupil are represented by these higher-order Zernike modes.

“High-order” aberrations of an eye as used herein refers to monochromatic aberrations beyond defocus and astigmatism, namely, third order, fourth order, fifth order, and higher order wavefront aberrations.

“The fluorescein pattern of a contact lens” refers to a fluorescent pattern formed by staining tears flowing under the contact lens with a high molecular weight fluorescein compound and observed with a Burton lamp or through the cobalt blue filter of a slit-lamp or the like. This pattern can be used to evaluate the relative tear film thickness between the contact lens and the cornea. A “bearing” area refers is an area where there is little fluorescein detected in the tear and where the lens may have or almost have a direct contact with the cornea. A “pooling” area is an area where there is relative large clearance between the lens and cornea shown by its fluorescence intensity (derived from fluorescein) being higher than surrounding areas.

As used herein, the term “directional stiffening effect” in reference to a stiffening rib feature is intended to describe that a soft lens can be flexed more easily in a direction substantially parallel to the longitudinal line of a stiffening rib feature than in a directional substantially perpendicular to the longitudinal line of the stiffening rib feature. In accordance with the invention, the stiffening direction of each stiffening rib feature is defined by the longitudinal line of the stiffening rib feature.

The invention is based partly on the discovery that localized thickening of a portion of a soft contact lens can stiffen locally that lens portion while maintain the overall softness of the soft contact lens and that, when incorporating a stiffening rib feature in a non-optical zone of a soft contact lens and near an area having localized and excessive pressure, one can partially spread the localized and excessive pressure from the area to a much enlarged area. Without increasing significantly the force causing the localized and excessive pressure on a cornea, any enlargement of that lens area can effectively reduce the pressure and as such, a stiffening rib feature in a non-optical zone of a soft contact lens can providing an even distribution of pressure from the lens over the cornea of an eye.

A stiffening rib feature's capability to spread a localized and excessive pressure can find particular use in designing a soft toric or translating multifocal contact lens which comprises orientation stabilizing and/or translating features, such as, for example, a prism ballast, a facet, or a ridge. These orientation stabilizing and/or translating features may inadvertently cause uneven distribution of pressure from the lens over the cornea of an eye and may influence the structural properties and dynamic load of the contact lens beyond these features' physical limits. It has found that the fluorescein pattern of a soft translating bifocal lens with a ridge shows a large area of fluorescein-pooling in the area around the ridge and an area of ‘bearing’ above the ridge but near the edge of the lens on either of the nasal and temporal sides. It is believed that thickening of the lens in the ridge area may locally stiffen the ridge area and may transmit part of dynamic load from the ridge area to the other areas to create excessive localized pressure (shown by the ‘bearing’ areas). By incorporating a stiffening rib feature in a non-optical zone of a soft contact lens near an area having localized and excessive pressure, one may be able to partially spread a dynamic load from a small area to a much larger area and thereby reduce the localized and excessive pressure. An even distribution of pressure from the lens over the cornea of an eye may be achievable by using a stiffening rib feature.

It is believed that a stiffening rib feature functions like a half batten in a sail. The effect on sail shape is greatly influenced in the immediate proximity of the batten as would be expected. The stiffening effect of the batten also extends beyond the batten's physical limits. A stiffening rib feature can be utilized in the soft lens design to influence and/or control localized stiffness, dynamic load distribution throughout the contact lens structure and lens-eye bearing point location.

The invention is further based partly on the discovery that at least one pair of stiffening rib features can be symmetrically arranged in a non-optical zone on either side of a vertical meridian plane to provide localized and directional stiffening effects on lens structure, wherein combination of the directions of the pair of stiffening rib features is parallel to the vertical meridian. Under the influence of eyelid action (blinking), undesirable lens flexures can occur, which in turn may adversely affect lens orientation stability (consistent and correct lens orientation) on eye and/or vertical translation of the optical zones of a translating bifocal soft contact lens across the pupil when the eye changes from primary (horizontal) gaze to a downward gaze. With a pair of stiffening rib features symmetrically arranged on either side of a vertical meridian plane and in a non-optical zone of a soft lens, one can stiffen the soft lens in a direction substantially parallel to the vertical meridian plane and as such, the undesirable lens flexures resulted from eyelid action can be minimized or eliminated.

Stiffening rib features will find particular use in achieving and maintaining consistent and correct on-eye lens orientation. It is generally believed that the on-eye orietantion of a contact lens is determined by a balance of lens adhesion to the eye, the effect of gravity and position of the center of gravity and the influnce of the eyelids (see, Brien A. Holden, Aust J. Optom. 58 (1975), 279-299, herein incorporated by reference in its entirety). Incorporation of stiffening rib features in a lens design will allow to locally stiffen a soft contact lens while retaining overall softness of the soft contact lens. With localized and in particular directional stiffening effect, one may increase on-eye mobility of a soft lens and as such, orientation stabilizing features may function more properly and effectively as designed intentionally based on mechanisms of gravity effect and “watermelon seed” principle (i.e., Upper eyelid pressure applied to the prism ballast wedge follows the “watermelon seed” principle of rapid movement away from the wedge apex. See, A. J. Hanks and B. Optom, Contact lens Forum, 31-35 (1983), herein incorporated by reference in its entirety). Therefore, stiffening rib features of the invention, in combination with orientation stabilizing features known in the art, may be able to maintain balance of forces for consistent and correct lens orientation on an eye during lens translation or eye lid movement. In particular, they may be able to enhance/control the on-eye translation of a soft translation multifocal contact lens.

The invention, in one aspect, provides a method for making a soft contact lens which is characterized by having an even distribution of pressure from the lens over the cornea of an eye. The method of the invention comprises a step of incorporating at least one stiffening rib feature in a non-optical zone of a contact lens in or near an area having a localized and excessive pressure to provide localized stiffening effects on lens structure and to have a dynamic load causing the localized and excessive pressure to be spread over an enlarged area, thereby providing an even distribution of pressure from the lens over the cornea of an eye.

In accordance with this aspect of the invention, a resultant soft contact lens can be a soft contact lens for correcting any types of vision deficiencies, including, without limitation, myopia, hypermetropia, presbyopia, astigmatism, prism, and high-order monochromatic aberrations. Preferably, a resultant soft contact lens is a soft lens for vision correction which requires on-eye lens orientation stability and/or vertical lens translation across the eye. Examples of such preferred lenses include without limitation a toric lens, a toric multifocal lens, a translating multifocal lens, a customized lens. A soft contact lens of the invention is preferably comprised of a hydrogel material having a modulus of less than about 2.0 N/mm², preferably less than about 1.5 N/mm², more preferably less than about 1.0 N/mm², even more preferably less than about 0.8 N/mm².

A lens area having localized and excessive pressure on the cornea can be determined by examining the fluorescein pattern of a test lens (shown by bearing area in the fluorescein pattern) or alternatively by analysis of a computer simulation of a lens design. The test lens is made according to a lens design. After finding a location of a bearing area on the test lens, one can incorporate a stiffening rib feature in an improved or final lens design for making contact lenses. For example, a stiffening rib feature can be added to provide localized stiffening effects on lens structure and to have a dynamic load causing the localized and excessive pressure to be spread over an enlarged area, thereby reducing the localized and excessive pressure.

In accordance with the invention, the stiffening rib feature has a lens thickness sufficient to provide localized stiffening effects on lens structure and to spread the localized and excessive pressure from the area to other lens areas, thereby providing an even distribution of pressure from the lens over the cornea of an eye. A stiffening rib feature of the invention has a maximum height of up to about 150 microns, preferably up to about 100 microns, more preferably up to about 75 microns above the anterior surface of a lens. The stiffening rib feature has a maximum width of about 2.0 mm or less, more preferably about 1.5 mm or less, even more preferably about 1.0 mm or less and a maximum length of from about 2.0 mm to about 10.0 mm.

The invention, in another aspect, provides a method for making a soft contact lens which is characterized by being able to maintain balance of forces for consistent and correct on eye lens orientation. The method of the invention comprises a step of incorporating at least one pair of stiffening rib features in a non-optical zone of a contact lens having a vertical meridian and a mirror symmetry relative to the vertical meridian plan, wherein each of the pair of stiffening rib features is arranged on either side of the vertical meridian plane to provide localized and directional stiffening effects on lens structure, wherein combination of the directions of the pair of stiffening rib features is parallel to the vertical meridian.

In accordance with the aspect of the invention, a resultant soft contact lens can be any contact lens for vision correction which requires on-eye lens orientation stability and/or vertical lens translation across the eye. Examples of such lenses include without limitation a toric lens, a toric multifocal lens, a translating multifocal lens, a customized lens. A soft contact lens of the invention is preferably comprised of a hydrogel material having a modulus of less than about 2.0 N/mm², preferably less than about 1.5 N/mm², more preferably less than about 1.0 N/mm², even more preferably less than about 0.8 N/mm².

The invention, in a further aspect, provides a soft contact lens which requires on-eye lens orientation and/or vertical lens translation for effectively correcting vision deficiency. The contact lens of the invention comprises an anterior surface, an opposite posterior surface, a vertical meridian plane and at least one pair of stiffening rib features. The anterior surface has a mirror symmetry with respect to the vertical meridian plane, is continuous at least in first derivative, and includes a vertical meridian, a horizontal meridian, a central optical zone and a peripheral zone extending outwardly from the central optical zone to lens edge. The pair of stiffening rib features are located in the peripheral zone and on either side of the vertical meridian plane to provide localized and directional stiffening effects on lens structure, wherein combination of the stiffening directions of the pair of stiffening rib features is parallel to the vertical meridian.

The central optical zone can have any shape suitable for a contact lens design, for example, such as circular, oval, or the like. Preferably, the central optical zone is circular. A circular central optical zone can be concentric with the geometric center of the anterior or posterior surface, or has a center deviating from the geometric center of the anterior or posterior surface by up to 2 mm. Where the central optical zone is concentric with the geometric center of the anterior or posterior surface, the vertical and horizontal meridians each pass through the center of the central optical zone. Where the center of the central optical zone deviates from the geometric center of the anterior or posterior surface, the center of the optical zone is on the vertical meridian and preferably less than about 1.0 mm from the geometric center of the anterior surface.

The peripheral zone can be composed of one or more peripheral bands or regions which are patched together to form a continuous surface. The peripheral blending zone can be any surface described by a mathematical function, preferably a spline-based mathematical function, or made of different tangent surface patches.

Preferably, the peripheral zone comprises orientation stabilization and/or translation features therein. Any suitable orientation stabilization and translation features can be used. Various orientation stabilization features have been disclosed in the prior art, including without limitation, various prism ballast designs, peri-ballast designs in which the prismatic thickness profile changes are confined in non-optical zone(s) surrounding the optical zone of the lens, a ridge feature which orients the lens by interacting with the eyelid, double slab-off features which have a top slab-off zone and a bottom slab-off zone zones to maintain the lens orientation, dynamic stabilization features disclosed in US published patent application Nos. 2002/0071094 and 2002/0024631 (herein incorporated by references in their entireties). Preferred examples includes orientation stabilization and translation features disclosed in co-pending U.S. patent application Ser. No. 10/848,791 filed May 19, 2004 (herein incorporated by reference in its entirety) and in U.S. Pat. No. 6,467,903 (herein incorporated by reference in its entirety).

In accordance with the invention, each stiffening rib feature crosses over the horizontal meridian, namely extending from a position below the horizontal meridian to a position above the horizontal meridian. Preferably, from about 5% to about 70% of each stiffening rib feature is located below the horizontal meridian whereas the rest is above the horizontal meridian. More preferably, from about 5% to about 40% of each stiffening rib feature is located below the horizontal meridian whereas the rest is above the horizontal meridian.

In a preferred embodiment, when projected on a plane perpendicular to the vertical meridian plan, the longitudinal line of each stiffening rib feature intersect with the vertical meridian at an angle of less than about 48° (i.e., with respect to the top of the vertical meridian) or between about 130° and about 180° (i.e., with respect to the bottom of the vertical meridian).

In accordance with the invention, each of the pair of stiffening rib features has a lens thickness sufficient to provide localized and directional stiffening effects on lens structure. A stiffening rib feature of the invention has a maximum height of up to about 150 microns, preferably up to about 100 microns, more preferably up to about 75 microns above the anterior surface of a lens.

In accordance with the invention, each of the pair of stiffening rib features has a maximum width of about 2.0 mm or less, more preferably about 1.5 mm or less, even more preferably about 1.0 mm or less and a maximum length of from about 2.0 mm to about 10.0 mm.

In accordance with the invention, combination of the stiffening directions of the pair of stiffening rib features is parallel to the vertical meridian and as such, a balance of lens adhesion to the eye, the effect of gravity, position of the center of gravity, and the influnce of the eyelids can be maintained in a soft contact lens of the invention.

In a preferred embodiment of a contact lens of the invention, the peripheral zone comprises a peripheral blending zone located on the inner boundary with the central optical zone and immediately surrounding the central optical zone, wherein the peripheral blending zone has a surface which ensures that the peripheral zone, the peripheral blending zone and the central optical zone are tangent to each other.

The presence of a peripheral blending zone can allow the separate and independent design of the central optical zone and the peripheral zone, so as to ensure a continuous transition from the central optical zone to the peripheral zone. With a blending zone between the central optical zone and the peripheral zone, a contact lens can be produced without flexion points and/or sharp boundaries at the junction between two zones and thereby provide improved wearer's comfort. In addition, the blending zone between the central optical zone and the peripheral zone can de-couple the optical features and the mechanical stabilization and translation features of the lens, thus preventing the introduction of prism into the optics. The peripheral blending zone can be any surface described by a mathematical function, preferably a spline-based mathematical function, or made of different tangent surface patches.

In accordance with the aspect of the invention, a resultant soft contact lens can be any contact lens for vision correction which requires on-eye lens orientation stability and/or vertical lens translation across the eye. Examples of such lenses include without limitation a toric lens, a toric multifocal lens, a translating multifocal lens, a customized lens. A soft contact lens of the invention is preferably comprised of a hydrogel material having a modulus of less than about 2.0 N/mm², preferably less than about 1.5 N/mm², more preferably less than about 1.0 N/mm², even more preferably less than about 0.8 N/mm².

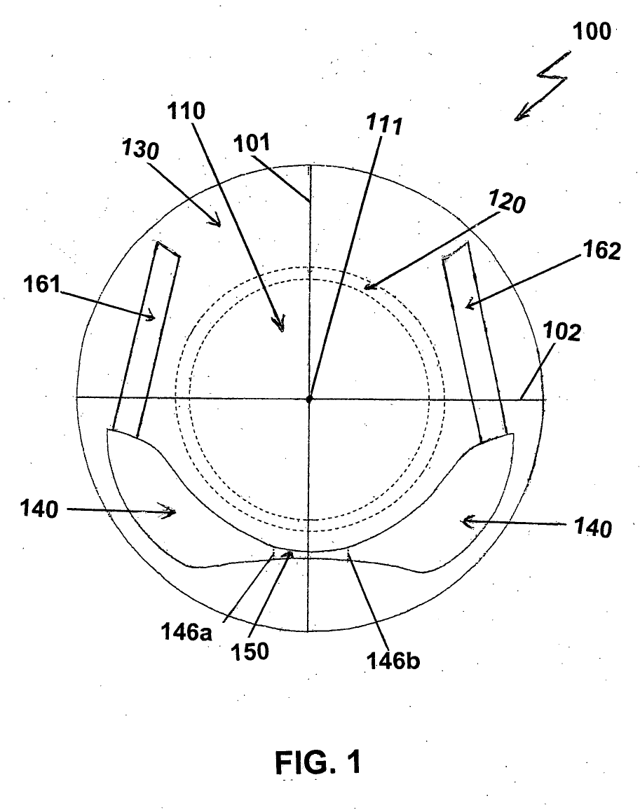

FIG. 1 illustrates a plan view of the anterior surface of a contact lens according to a preferred embodiment of the invention. The contact lens 100 comprises an anterior surface (shown in FIG. 1) and an opposite posterior surface (not shown). The anterior surface includes a vertical meridian 101, a horizontal meridian 102, a circular central optical zone 110, an annular peripheral blending zone 120 extending outwardly from the central optical zone 110, and an annular peripheral zone 130 extending outwardly from the peripheral blending zone 120.

The central optical zone 110 is a circular zone which is concentric with the geometric center of the anterior surface. The central optical zone 110 in combination with the posterior surface provides one or more vision corrections, for example, such as astigmatism, presbyopia, prism, high-order monochromatic aberrations (e.g., a non-standard amount of spherical aberration, coma, etc.), or combinations thereof.

The anterior surface has a mirror symmetry with respect to a vertical meridian plane (cuting through the vertical meridian 101 in a direction parallel to the optical axis of the lens) and is continuous at least in first derivative. The contact lens is weighted at its lower half portion by incorporating, in the peripheral zone 130, two on-eye orientation stabilizing features 140 which are bridged by a horizontal stiffening rib feature 150 having boundaries (146a, 146b) with the orientation stabilizing features 140. Each orientation stabilizing feature 140 is a convexly thickened area extending outwardly (rising) from the anterior surface of a soft contact lens. The lens thickness of each orientation stabilizing feature 140 increases gradually along each semi-meridian from its inner boundary (i.e., its intersection points with any semi-meridian which are close to the geometrical center 111 of the lens) until reaching a maximum thickness and then decreases to the outer boundary (i.e., its intersection points with any semi-meridian which are away from the geometrical center 111). Lens thickness maximums of each orientation stabilizing feature along semi-meridians are preferably located slightly inside of the outer boundary. Along a line parallel to the vertical meridian 101 from top to bottom, the lens thickness of each orientation stabilizing feature 140 increases gradually until reaching a maximum thickness and then decreases.

Lens thickness of the horizontal stiffening rib feature 150 remain substantially constant along any lines parallel to the horizontal meridian 102. Preferably, lens thickness of the horizontal stiffening rib feature 150 is thinner than the maximum lens thickness of the orientation stabilizing features 140 along any lines parallel to the horizontal meridian 102. More preferably, lens thickness of the horizontal stiffening rib feature 150 is equal to or thinner than lens thickness of the orientation stabilizing features 140 at intersections of the boundary lines (146a, 146b) with any lines parallel to the horizontal meridian 102.

The peripheral zone 130 also includes twin stiffening rib features 161, 162 arranged on either side of the vertical meridian 101. Lens thickness of each of twin stffening rib features (161, 162) is substantially constant from top to bottom along its longitudinal line, or preferably increases slightly from top to bottom along its longitudinal line, in a manner that the difference between the values of lens thickness at the top logitudinal end and at the bottom longitudinal end is less than 15%.

The twin stiffening rib features (161, 162), in combination with the horizontal stiffening rib feature 150, can locally stiffen lens structure in some lens area while keeping overall lens thickness relative thin, spread the localized and excessive pressure derived from the oritentation stabilizing features 140 over an much enlarged area to provide an even distribution of pressure from the lens over the cornea of an eye, and maintain balance of forces for consistent and correct lens orientation on an eye during eye lid movement.

It is preferably that the peripheral zone 130 further comprises a slab-off thin zone extending outwardly from the top edge of the central optical zone. Example of a slab-off thin zone is a ridge-off zone described in commonly assigned U.S. patent application Publication No. 2002/0021410 (herein incorporated by reference in its entirety). A slab-off-thin zone can add lens rotational stability and improve the comfort of the lens.

For a translating multifocal soft contact lens, It is preferably that each orientation stbilizing feature 140 can further comprise a ramped ridge as desclosed in a commonly assigned co-pending US patent application Publication No. 2004/0017542 (herein incorporated by reference in its entirety). Each of the two ramped ridges (one in one of the two orientation stabilizing features) has an upper edge, flattened lower ramp edge, a latitudinal ridge extends outwardly from the anterior surface, and a ramp that extends downwardly from the lower ramped edge to surrounding surface and has a curvature or slope that provides a varying degree of interaction between the ramped ridge and the lower eyelid depending on where the lower eyelid of the eye strikes the ramped ridge. The two ridges are mirror symmetric with each other with respect to the vertical meridian plan. Both of the ridges together are able to control lens position on the eye in primary gaze and/or translation amount across the surface of the eye when the eye changes from gazing at an object at a distance to gazing at an object at an intermediate distance or to gazing at a nearby object. A ramped ridge has a continuous surface defined by any mathematical function (e.g., a conic or spline-based mathematical function) or made of several different surface patches.

The peripheral blending zone 120 has a surface that ensures that the peripheral zone 130, the peripheral blending zone 120 and the central optical zone 110 are tangent to each other. The peripheral blending zone 120 is preferably defined by a spline-based mathematical function. The peripheral blending zone 120 between the central optical zone 110 and the peripheral zone 130 can de-couple the optical features and the mechanical stabilization and translation features of the lens, thus preventing the introduction of prism into the optics.

A contact lens of the invention can be designed using any known, suitable optical design system. Exemplary optical computer aided design systems for designing an optical model lens includes, but are not limited to ZEMAX (ZEMAX Development Corporation). Preferably, the optical design will be performed using ZEMAX (ZEMAX Development Corporation). The design of the optical model lens can be transformed by, for example, a mechanical computer aided design (CAD) system, into a set of mechanical parameters for making a physical lens. Any known suitable mechanical CAD system can be used in the invention. The design of an optical model lens may be translated back and forth between the optical CAD and mechanical CAD systems using a translation format which allows a receiving system, either optical CAD or mechanical CAD, to construct NURBs (non-uniform rational B-splines), Bézier surfaces of an intended design or ASCII parameters that control a parametric design. Exemplary translation formats include, but are not limited to, VDA (verband der automobilindustrie) and IGES (Initial Graphics Exchange Specification). By using such translation formats, overall surface of lenses can be in a continuous form that facilitates the production of lenses having radial asymmetrical shapes. Bézier and NURBs surface are particular advantageous for a lens having a plurality of zones including optical zone and non-optical zones because multiple zones can be blended, analyzed and optimized. More preferably, the mechanical CAD system is capable of representing precisely and mathematically high order surfaces. An example of such mechanical CAD system is Pro/Engineer from Parametric Technology.

An “optical model lens” refers to an ophthalmic lens that is designed in a computer system and generally does not contain other non-optical features that constitute an ophthalmic lens.

When transforming the design of an optical model lens into a set of mechanical parameters, common feature parameters of a family of ophthalmic lenses can be incorporated in the lens designing process. Examples of such parameters include shrinkage, non-optical boundary zone and its curvature, center thickness, range of optical power, and the like.

Any mathematical function can be used to describe the optical zone and non-optical zones of a contact lens of the invention, as long as they have sufficient dynamic range that allow the design of that lens to be optimized. Exemplary mathematical functions include conic, biconic and quadric functions, polynomials of any degree, Zernike polynomials, exponential functions, trigonometric functions, hyperbolic functions, rational functions, Fourier series, and wavelets. Preferably, a spline-based mathematical function or a combination of two or more mathematical functions are used to describe the optical zone and non-optical zones of a contact lens of the invention.

A contact lens of the invention may be produced by any convenient manufacturing means, including, for example, a computer-controllable manufacturing device, molding or the like. A “computer controllable manufacturing device” refers to a device that can be controlled by a computer system and that is capable of producing directly a contact lens or optical tools for producing a contact lens. Any known, suitable computer controllable manufacturing device can be used in the invention. Exemplary computer controllable manufacturing devices includes, but are not limited to, lathes, grinding and milling machines, molding equipment, and lasers. Preferably, a computer controllable manufacturing device is a two-axis lathe with a 45° piezo cutter or a lathe apparatus disclosed by Durazo and Morgan in U.S. Pat. No. 6,122,999 (herein incorporated by reference in its entirety), or is a numerically controlled lathe, for example, such as Optoform® ultra-precision lathes (models 30, 40, 50 and 80) having Variform® or Varimax piezo-ceramic fast tool servo attachment from Precitech, Inc.

Preferably, contact lenses are molded from contact lens molds including molding surfaces that replicate the contact lens surfaces when a lens is cast in the molds. For example, an optical cutting tool with a numerically controlled lathe may be used to form a metallic optical tool incorporating the features of the anterior surface of a contact lens of the invention. The tool is then used to make anterior surface molds that are then used, in conjunction with posterior surface molds, to form the lens of the invention using a suitable liquid lens-forming material placed between the molds followed by compression and curing of the lens-forming material.

Preferably, a contact lens of the invention or the optical tool to be used for making the same is fabricated by using a numerically controlled lathe, for example, such as Optoform® ultra-precision lathes (models 30, 40, 50 and 80) having Variform® or Varimax piezo-ceramic fast tool servo attachment from Precitech, Inc, according to a method described in a commonly assigned co-pending U.S. patent application Ser. No. 10/616,378 filed Jul. 9, 2003 and Ser. No. 10/616,476 (U.S. patent application Publication No. 2004/0017542), herein incorporated by reference in their entireties, in which after converting a lens design to geometry of a contact lens to be produced in a manufacturing system, a mini-file, or equivalent format, containing both the information for the header and the information about the geometry of the lens is generated. After the mini-file is completed, it is loaded into an Optoform® ultra-precision lathe (models 30, 40, 50 or 80) having Variform® piezo-ceramic fast tool servo attachment and run to produce a contact lens of the invention.

The invention, in still a further aspect, provides a series of soft contact lenses capable of correcting different vision deficiencies, wherein each contact lens in the series comprises an anterior surface and a posterior surface, wherein the posterior surface of each lens in the series is substantially identical to each other, wherein the anterior surface of each lens in the series include: a vertical meridian, a horizontal meridian, a central optical zone, a peripheral zone, a blending zone extending outwardly from the central optical zone to the peripheral zone and providing a continuous transition from the central optical zone to the peripheral zone, wherein the peripheral zone of each lens in the series is identical to each other whereas the central optical zone and the blending zone of each lens in the series are different from each other. The anterior surface of each lens has a mirror symmetry with respect to a vertical meridian plane and is continuous at least in first derivative. The peripheral zone includes at least one pair of stiffening rib features which are located in the peripheral zone and on either side of the vertical meridian plane to provide localized and directional stiffening effects on lens structure. Each stiffening rib feature crosses over the horizontal meridian. Combination of the directions of the pair of stiffening rib features is parallel to the vertical meridian.

In a preferred embodiment, each lens is weighted at its lower half portion by incorporating, in the peripheral zone below the horizontal meridian, two identical on-eye orientation stabilizing features, one located on left side of the vetical meridian plane and the other on right side of the vertical meridian plan, wherein each orientation stabilizing feature is a convexly thickened areas extending outwardly from the anterior surface, wherein each orientation stabilizing feature has a lens thickness profile characterized by: (1) that its lens thickness increases gradually along each semi-meridian from its inner boundary until reaching a maximum thickness and then decreases to the outer boundary; (2) that its lens thickness maximums of each orientation stabilizing feature along semi-meridians are preferably located slightly inside of the outer boundary; (3) that, along any line parallel to the vertical meridian in a direction from from top to bottom, its lens thickness increases gradually until reaching a maximum thickness and then tapers off with the anterior surface.

In another preferred embodiment, each contact lens is weighted at its lower half portion by incorporating, in the peripheral zone below the horizontal meridian, two identical on-eye orientation stabilizing features, one located on left side of the vetical meridian plane and the other on right side of the vertical meridian plan, wherein each orientation stabilizing feature is a convexly thickened areas extending outwardly from the anterior surface, wherein each orientation stabilizing feature has a lens thickness profile characterized by: (1) that its lens thickness increases gradually along each semi-meridian from its inner boundary until reaching a maximum thickness and then decreases to the outer boundary; (2) that its lens thickness maximums of each orientation stabilizing feature along semi-meridians are preferably located slightly inside of the outer boundary; (3) that, along any line parallel to the vertical meridian in a direction from from top to bottom, its lens thickness increases gradually until reaching a maximum thickness and then tapers off with the anterior surface. Preferably, the two orientation stabilizing features are bridged by a horizontal stiffening rib feature located below the central optical zone, wherein along any lines parallel to the horizontal meridian lens thickness of the horizontal stiffening rib feature remain substantially constant and is thinner than the maximum lens thickness of the orientation stabilizing features.

In accordance with a preferred embodiment of the invention, from about 5% to about 70% of each stiffening rib feature is located below the horizontal meridian whereas the rest is above the horizontal meridian.

In accordance with another preferred embodiment of the invention, when projected on a plane perpendicular to the vertical meridian plan, the longitudinal line of each stiffening rib feature intersects with the vertical meridian at an angle of less than about 48° with respect to the top of the vertical meridian or between about 130° and about 180° with respect to the bottom of the vertical meridian.

In accordance with another preferred embodiment of the invention, each contact lens is weighted at its lower half portion by incorporating, in the peripheral zone and below the horizontal meridian, at least one orientation stabilizing feature, wherein the orientation stabilizing feature is a convexly thickened areas extending outwardly (rising) from the anterior surface and has a mirror symmetry with respect to the vertical meridian plan, wherein the orientation stabilizing feature has a lens thickness profile characterized by: (1) that its lens thickness increases gradually along each semi-meridian from its inner boundary until reaching a maximum thickness and then decreases to the outer boundary; (2) that its lens thickness maximums of each orientation stabilizing feature along semi-meridians are preferably located slightly inside of the outer boundary; (3) that, along any line parallel to the vertical meridian in a direction from from top to bottom, its lens thickness increases gradually until reaching a maximum thickness and then tapers off with the anterior surface.

In accordance with another preferred embodiment of the invention, the peripheral zone further comprises a slab-off thin zone extending outwardly from the top edge of the central optical zone.

In accordance with another preferred embodiment of the invention, the two orientation stabilizing features are bridged by a horizontal stiffening rib feature located below the central optical zone, wherein along any lines parallel to the horizontal meridian lens thickness of the horizontal stiffening rib feature remain substantially constant and is thinner than the maximum lens thickness of the orientation stabilizing features.

The invention has been described in detail, with particular reference to certain preferred embodiments, in order to enable the reader to practice the invention without undue experimentation. A person having ordinary skill in the art will readily recognize that many of the previous components, compositions, and/or parameters may be varied or modified to a reasonable extent without departing from the scope and spirit of the invention. Furthermore, titles, headings, example materials or the like are provided to enhance the reader's comprehension of this document, and should not be read as limiting the scope of the present invention. Accordingly, the invention is defined by the following claims, and reasonable extensions and equivalents thereof.

What is claimed is:

1. A method for making a soft contact lens which requires on-eye lens orientation and/or on-eye vertical lens translation for effectively correcting vision deficiency, the method comprising the steps of:
designing a contact lens including an anterior surface, an opposite posterior surface, a vertical meridian plane and at least one pair of stiffening rib features,
wherein the anterior surface has a mirror symmetry with respect to the vertical meridian plane, is continuous at least in first derivative, and includes a vertical meridian, a horizontal meridian, a central optical zone and a peripheral zone extending outwardly from the central optical zone to lens edge, wherein the pair of stiffening rib features are located in the peripheral zone and on either side of the vertical meridian plane, wherein each stiffening rib feature crosses over the horizontal meridian, and wherein combination of the stiffening directions of the pair of stiffening rib features is parallel to the vertical meridian.

2. The method of claim 1, wherein from about 5% to about 70% of each stiffening rib feature is located below the horizontal meridian whereas the rest is above the horizontal meridian.

3. The method of claim 2, wherein the central optical zone is a substantially circular zone which is concentric with the geometric center of the anterior or posterior surface, or has a center deviating from the geometric center of the anterior or posterior surface by up to 2 mm.

4. The method of claim 3, wherein the peripheral zone comprises one or more orientation stabilization features and/or one or more translation features therein.

5. The method of claim 4, wherein, when projected on a plane perpendicular to the vertical meridian plan, the longitudinal line of each stiffening rib feature intersects with the vertical meridian at an angle of less than about 48° with respect to the top of the vertical meridian or between about 130° and about 180° with respect to the bottom of the vertical meridian.

6. The method of claim 4, the peripheral zone comprises a peripheral blending zone located on the inner boundary with the central optical zone and immediately surrounding the central optical zone, wherein the peripheral blending zone has a surface which ensures that the peripheral zone, the peripheral blending zone and the central optical zone are tangent to each other.

7. A method for making a soft contact lens, which comprises an anterior surface and an opposite posterior surface, the method comprising a step of incorporating at least one stiffening rib feature in a non-optical zone of a contact lens in or near an area having localized and excessive pressure to provide localized stiffening effects on lens structure and to have a dynamic load causing the localized and excessive pressure to be spread over an enlarged area, thereby providing an even distribution of pressure from the lens over the cornea of an eye.

8. The method of claim 7, wherein the soft contact lens a soft lens for vision correction which requires on-eye lens orientation stability and/or vertical lens translation across the eye.

9. The method of claim 8, wherein the soft lens is a toric lens, a toric multifocal lens, a translating multifocal lens, or a customized lens.

10. A method for making a soft contact lens, comprising the steps of:
obtaining a test lens based on a lens design;
examining the fluorescein pattern of the test lens to determine a lens area having localized and excessive pressure on the cornea;
incorporating an stiffening rib feature in or near the lens area in a non-optical zone of a lens in an improved lens design, to provide localized stiffening effects on lens structure and to have a dynamic load causing the localized and excessive pressure to be spread over an enlarged area; and
making the soft contact lens according to the improved lens design, wherein the obtained soft contact lens is characterized by having even distribution of pressure from the lens over the cornea of an eye.

11. The method of claim 10, wherein the soft lens is a toric lens, a toric multifocal lens, a translating multifocal lens, or a customized lens.

12. A soft contact lens, comprising:
an anterior surface;
an opposite posterior surface;
a vertical meridian plan; and
at least one pair of stiffening rib features,
wherein the anterior surface has a mirror symmetry with respect to the vertical meridian plane, is continuous at least in first derivative, and includes a vertical meridian, a horizontal meridian, a central optical zone and a peripheral zone extending outwardly from the central optical zone to lens edge,
wherein the pair of stiffening rib features are located in the peripheral zone and on either side of the vertical meridian plane to provide localized and directional stiffening effects on lens structure,
wherein each stiffening rib feature crosses over the horizontal meridian,
wherein combination of the stiffening directions of the pair of stiffening rib features is parallel to the vertical meridian.

13. The soft contact lens of claim 12, wherein from about 5% to about 70% of each stiffening rib feature is located below the horizontal meridian whereas the rest is above the horizontal meridian.

14. The soft contact lens of claim 13, wherein from about 5% to about 40% of each stiffening rib feature is located below the horizontal meridian whereas the rest is above the horizontal meridian.

15. The soft contact lens of claim 13, wherein the central optical zone is a substantially circular zone which is concentric with the geometric center of the anterior or posterior surface, or has a center deviating from the geometric center of the anterior or posterior surface by up to 2 mm.

16. The soft contact lens of claim 15, wherein the peripheral zone comprises one or more orientation stabilization features and/or one or more translation features therein.

17. The soft contact lens of claim 16, wherein, when projected on a plane perpendicular to the vertical meridian plan, the longitudinal line of each stiffening rib feature intersects with the vertical meridian at an angle of less than about 48° with respect to the top of the vertical meridian or between about 130° and about 180° with respect to the bottom of the vertical meridian.

18. The soft contact lens of claim 16, the peripheral zone comprises a peripheral blending zone located on the inner boundary with the central optical zone and immediately surrounding the central optical zone, wherein the peripheral blending zone has a surface which ensures that the peripheral zone, the peripheral blending zone and the central optical zone are tangent to each other.

19. The soft contact lens of claim 16, wherein the contact lens is weighted at its lower half portion by incorporating, in the peripheral zone and below the horizontal meridian, at least one orientation stabilizing feature, wherein the orientation stabilizing feature is a convexly thickened areas extending outwardly (rising) from the anterior surface and has a mirror symmetry with respect to the vertical meridian plan, wherein the orientation stabilizing feature has a lens thickness profile characterized by: (1) that its lens thickness increases gradually along each semi-meridian from its inner boundary until reaching a maximum thickness and then decreases to the outer boundary; (2) that its lens thickness maximums of each orientation stabilizing feature along semi-meridians are preferably located slightly inside of the outer boundary; (3) that, along any line parallel to the vertical meridian in a direction from from top to bottom, its lens thickness increases gradually until reaching a maximum thickness and then tapers off with the anterior surface.

20. The soft contact lens of claim 19, wherein the peripheral zone further comprises a slab-off thin zone extending outwardly from the top edge of the central optical zone.
